(19) United States
(12) Patent Application Publication
(10) Pub. No.: US 2003/0026274 A1
(43) Pub. Date: Feb. 6, 2003

(54) Switching process and apparatus for the transmission of user data packets

(76) Inventor: Ole Droz, Poecking (DE)

Correspondence Address: BELL, BOYD & LLOYD, LLC, P. O. BOX 1135, CHICAGO, IL, 60690-1135, US

(21) Appl. No.: 09/921,393

(22) Filed: Aug. 2, 2001

(30) Foreign Application Priority Data
Aug. 2, 2001 (DE) 100 37 726.2

(51) Int. Cl. H04L 12/28

(52) U.S. Cl. 370/410; 370/522

(57) ABSTRACT

A process in which a signaling unit contains at least two line units which are used when setting up a connection for the transmission of user data in data packets wherein the line units in each case terminate the signaling with respect to one of the terminal devices involved in the data transmission and exchange internal signaling messages with one another to allow the signaling to be carried out in a simple manner.

### BACKGROUND OF THE INVENTION

1. Field of the Invention

The present invention relates to a switching process for the transmission of user data packets. The user data are transmitted in a data transmission network in data packets. The transmission takes place on the basis of data packets. Although data packets can also be transmitted in circuit-switched networks, the associated transmission and onward transfer between the network nodes does not take place on the basis of data packets, but rather on the basis of time slots.

2. Description of the Prior Art

A data packet usually contains a packet header and a packet body. In the packet header there is information on the onward transfer of the data packet; for example, a destination address and a sender address. There are also data packets which further contain signaling information in the packet header, required in the case of transmission in accordance with protocols of higher protocol layers. In the packet body are the user data. Examples of networks in which user data are transmitted on a packet basis are the ATM network (Asynchronous Transfer Mode) and the Internet, or what are known as intranets, in which the data packets are transmitted in accordance with the Internet protocol.

In addition to the networks in which data packets are transmitted, there are also circuit-switched networks. The switching here includes a connection set-up phase, in which resources of the network are assigned for the connection and in which various transmission channels are interconnected. The data are then transmitted and passed on in time slots. In the connection tear-down phase, the assigned resources are released again, the transmission channels being disconnected from one another.

In data-packet-transmitting networks, switching likewise takes place on higher protocol layers; i.e., there is a connection set-up phase, a transmission phase and a connection tear-down phase. In this case, signaling protocols are used. Until now, the signaling has, in principle, been terminated in the terminal devices; i.e., signaling messages are generated for the first time there and responses to received signaling messages are sent. Examples of such terminal devices are service-providing computers, known as servers, and service-using computers, known as clients.

Also known are network interworking units, which connect packet networks and circuit-switched networks. Such a network interworking unit is known, for example, from the standard H.323 (February 1998) “Packet Based Multimedia Communications Systems” of the ITU-T (International Telecommunication Union-Standardisation Sector Telecommunication). The network interworking unit is also referred to in this standard as a gateway. The network interworking unit terminates the signaling on each side; i.e., for two definitively predetermined protocols. On the packet network side, signaling is performed, for example, in accordance with the protocol H.323 and on the circuit-switched network side it is performed in accordance with the ISUP protocol (ISDN User Part).

It is an object of the present invention to specify an improved switching process for the transmission of user data packets. Furthermore, an associated signaling unit, an associated program and also a data carrier and a data network message with this program are to be specified.

### SUMMARY OF THE INVENTION

In the case of the process according to the present invention, a signaling unit contains at least three line units, which are used when setting up a connection for the transmission of user data in data packets. The user data are passed on in data packets of a network which transmits user data on the basis of data packets. The line units in each case terminate the signaling toward one of the terminal devices involved in the data transmission. The signaling messages arriving at one line unit for the switching of the data packets are passed on to the other line unit with the aid of internal signaling messages defined for the signaling unit.

The internal signaling messages are transmitted in accordance with an internal signaling protocol. The internal signaling protocol forms an interface between the two signaling protocols terminated in the outward direction at the line units. The internal signaling protocol is defined in such a way that it can be used both between line units which terminate the same signaling protocol in the outward direction and between line units which terminate different signaling protocols in the outward direction. One effect achieved by the defining of the internal signaling protocol and the internal signaling messages is that of modularization. This modularization leads to the possibility that line units for individual external signaling protocols can be developed independently of one another. Modularization also allows the signaling unit to be adapted to various tasks with little expenditure.

Regarded as a terminal device is a unit which generates electrically or optically transmittable data with the aid of a converter unit; for example, with the aid of an acoustic converter unit or with the aid of an image converter unit. A terminal device is also a unit which generates acoustic signals or image signals from optically or electronically received data with the aid of a converter unit. The terminal devices are usually used by subscribers. A third type of terminal device are units which automatically generate or automatically evaluate user data. This type of terminal device may also be located either in the signaling unit itself, in other signaling units or in other network nodes.

In the case of the process according to the present invention, the line units can be optionally connected to one another. This measure achieves the effect that the rigid connection between the line units previously customary in the signaling for packet-based networks can be eliminated. This opens up the possibility of arranging more than two line units in a signaling unit and connecting them to the signaling unit according to requirements. The requirements change, for example, load-dependently or on the basis of other circumstances. If, for example, one line unit fails, another line unit can be connected in its place to the peer line unit.

In the case of the process according to the present invention, as provided by a second embodiment, a signaling unit contains at least two line units, which are used when setting up a connection for the transmission of user data in data packets. The user data are passed on in data packets of a network which transmits user data on the basis of data packets. The line units in each case terminate the signaling toward one of the terminal devices involved in the data transmission in accordance with a signaling protocol for circuit-switched transmission of user data. The signaling messages arriving at one line unit for the switching of the data packets are passed on to the other line unit with the aid of internal signaling messages defined for the signaling unit. The two line units are either firmly connected to each other or can be optionally connected to each other.

In an embodiment, the line units can be connected via a switching network, which preferably transmits the internal signaling messages in channels. A transmission link, for example a line or a time slot in a predetermined time frame, is used as the transmission channel. As such, resources for the signaling are reserved in the switching network. The assignment of resources for individual signaling operations is justified, because approximately the same volumes of data have to be transmitted in both directions during signaling. With a switching network, a large number of line units can be connected to one another simultaneously. As an alternative to the switching network, a bus system or a data network can be used.

In a further embodiment, the connection of the line units is controlled according to the connection destination. This measure allows terminal devices which are connected to various other line units to be reached from one line unit; i.e., from the terminal devices connected to it. Since the number of terminal units which can be connected to a line unit is limited, or limitation is advisable due to a modular construction, very many connections can be switched on the basis of the optional connection possibility.

In an embodiment, a number of signaling messages are used for transmitting, in each case, an information element with the following contents:

an address at which the one terminal device in the packet-switched network can be reached;

a port number, which designates a receiving unit of a terminal device; and

a coding identification, which designates the type of coding used when sending data packets to a terminal device.

Alternatively, a number of signaling messages which in each case contain only one of the information elements mentioned are used. This facilitates a conversion from the external signaling protocols or a conversion to the external signaling protocols.

In an embodiment, the signaling unit contains further line units which serve, however, for the switching of connections for the transmission of user data in a circuit-switched network and consequently perform signaling in accordance with protocols for circuit-switched networks. The further line units use the same message interface for exchanging the internal signaling messages as the line units which switch the transmission of user data packets. In particular for the connection set-up between the various line units, the same signaling messages are used. Depending on the line unit, however, the contents of the signaling messages differ. This measure leads to only one interface having to be defined for the switching of user data for circuit-switched networks and for the switching in packet networks. This provides the prerequisite for being able to offer both types of switching with considerably reduced expenditure for the subscribers.

In another embodiment, at least one of the line units involved in the connection set-up operates in accordance with the ISUP protocol (ISDN User Part) or a protocol based on it. The essence of the ISUP protocol is defined, in particular, in the standards Q.763 and Q.764. By the inclusion of line units which terminate the signaling in the outward direction in accordance with the ISUP protocol, already tried-and-tested line units can be used for the switching in the transmission of user data packets and, consequently, for a new task. This saves on development expenditure. The line units previously used only have to be extended by a few functions; for example, by a function for determining an Internet address and by functions for driving a control unit which is connected to a packet-switching network. The control unit allows a network interworking unit for converting the user data to be achieved.

If both line units involved in the connection set-up operate in accordance with the ISUP protocol, the signaling unit can be connected between two conventional switching centers of the circuit-switched network. If all three line units involved in the connection set-up operate in accordance with the ISUP protocol, there are options in the connection set-up for the transmission in data packets. If appropriate, the two line units perform signaling in accordance with different types of protocol.

If one or two of the three line units performs or perform signaling in accordance with a signaling protocol for a packet network, there is the choice between protocol classes and not just between protocol types in the connection set-up.

In the next embodiment, at least one of the line units involved in the connection set-up operates in accordance with an ISUP protocol supplemented by information elements and permitting the transmission of the following information:

an address at which the one terminal device in the packet-switched network can be reached; and/or

a port number, which designates a receiving unit of a terminal device; and/or

a type of coding, which is to be used when sending data packets to a terminal device.

When supplementing the ISUP protocol, the transport mechanisms described in the standard Q.765 are preferably used; for example, the container structure BAT (Bearer Association Transport) specified there. This measure allows two signaling units of different operators to be used for the switching of a transmission path for user data packets. This is required, in particular, whenever the network interworking units of signaling units in different countries are being controlled. Within a signaling unit there is, for example, a line unit which operates in accordance with the extended ISUP protocol and a line unit which operates in accordance with the ISUP protocol.

In an embodiment, at least one of the line units involved in the connection set-up terminates the signaling in accordance with a signaling protocol for a packet-transmitting data network. A terminal device or another unit in a data-packet-transmitting network is connected to the line unit directly or via further signaling units. This measure allows the signaling to be performed link by link or else completely by using a data-packet-transmitting network. There are processes in which even two or three line units perform signaling in accordance with a signaling protocol for packet networks. The signaling protocols may differ. This increases the options in the connection set-up.

In a refinement with a line unit which operates in accordance with a signaling protocol for a packet-transmitting data network, the signaling protocol is a protocol for signaling with a terminal device, preferably the protocol H.323, the protocol SIP (Session Initiation Protocol) or the protocol MGCP (Media Gateway Control Protocol). The protocol H.323 was defined by the ITU-T. The protocol SIP and the protocol MGCP were defined by the IETF (Internet Engineering Task Force) in the de facto standards RFC2543 and RFC2705 (Request for Comment). However, other signaling protocols are also used. If a terminal device is connected to the line unit, the address to be used for the transmission of the user data, the access unit to be used and the type of coding are prescribed by the terminal device. The line unit itself only has to pass on these data.

In another embodiment with a line unit which performs signaling in accordance with a signaling protocol for a packet-transmitting data network, this signaling protocol is a protocol of a lower protocol layer, for example of the signaling layer. On a higher protocol layer, a protocol which was originally defined for a circuit-switched transmission network, for example the protocol ISUP or a protocol based on it, is used. This measure allows the customary type of signaling via the circuit-switched network or a type of signaling via the data-packet-transmitting network to be optionally chosen. For example, this takes place according to the traffic load in the two networks.

In the next embodiment, at least one of the line units involved in the connection set-up concerns a control unit, with the aid of which a network interworking unit can be achieved. For the signaling between the network interworking unit and the control unit, the packet-transmitting data network is preferably used. In the network interworking unit, after the connection set-up phase, the user data are removed from time slots and distributed among data packets and/or user data are disassembled from received data packets and passed on in time slots. The network interworking unit is consequently the interface for the user data between the packet-transmitting network and the circuit-switching network. The protocol MGCP (Media Gateway Control Protocol) is preferably used as the signaling protocol between the control unit and the network interworking unit, see RFC2705.

In an embodiment, the signaling unit contains a number of control units, which are respectively assigned to a line unit. The use of separate control units in the switching for the transmission of the same user data allows the half-call model also to be used in the case of user data transmitted in packets. It is consequently possible to continue to utilize the advantages associated with the half-call model.

In another embodiment, a line unit contains at least two component line units, which exchange internal signaling messages with one another. One component line unit in this case changes in the lower protocol layers from its internal signaling protocol to the internal signaling protocol with different messages occurring in higher protocol layers. The development is used for example in order to include a control unit.

In a next development, the user data are passed on in a connectionless mode by the network nodes of the packet-transmitting network, preferably in accordance with the Internet protocol. Alternatively, the user data are passed on in a connection-oriented mode by the network nodes of the packet-switching network, preferably in accordance with the ATM protocol (Asynchronous Transfer Mode). Connectionless or connection-oriented consequently relates to the network layer of what is known as the OSI model (Open Systems Interconnection).

The present invention also relates to a signaling unit which performs the steps of the aforementioned process of the present invention or the alternative embodiments. Consequently, the technical effects mentioned above also apply to the signaling unit.

In an embodiment, the signaling unit is a component part of a switching center for a circuit-switched network, wherein user data are switched in time slots in the switching center. However, functions for the switching of a transmission path for user data packets are also contained in the switching center. The user data packets themselves are not passed on via the switching center, but rather by the data-packet-transmitting network. Within the switching center, however, the same internal signaling messages are used for both types of signaling.

The present invention also relates to a program which, when executed with the aid of a processor, performs the steps of the process of the present invention or its developments. The program is stored, for example, in a memory module or is transmitted via the Internet.

Additional features and advantages of the present invention are describe in, and will be apparent from, the following Detailed Description of the Preferred Embodiments and the Drawings.

### DESCRIPTION OF THE DRAWINGS

FIG. 1 shows a switching center with a number of line units;

FIG. 2 shows functional units of the switching center for the connection of an H.323 terminal to a conventional telephone network;

FIG. 3 shows functional units of the switching center in conventional inter-exchange signaling and link-by-link data transmission via the telephone network, via the Internet and again via the telephone network;

FIG. 4 shows functional units of two switching centers for the switching of a data transmission taking place link by link via the telephone network, via the Internet and again via the telephone network; and

FIG. 5 shows functional units of two switching centers for the switching of a data transmission taking place link by link via the Internet and via the telephone network.

### DETAILED DESCRIPTION OF THE PREFERRED EMBODIMENTS

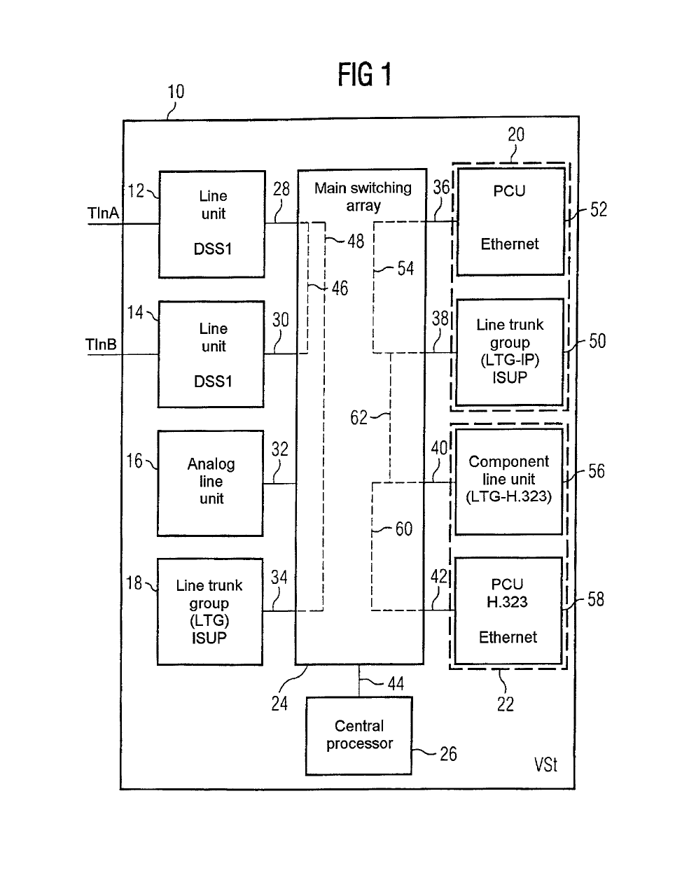

FIG. 1 shows a switching center 10 with a number of line units 12 to 22. The line units 12 and 14 serve for the connection of ISDN subscribers. The protocol DSS1 (Digital Signaling System No. 1) is used as the transmission protocol between the line unit 12 or 14 and the connected subscribers.

The line unit 16 serves for the connection of subscriber lines operating on an analog basis. The line unit 18 serves for the connection of the lines leading to a further switching center, which are also referred to as a trunk. The protocol ISUP (ISDN User Part) is used as the signaling protocol between the switching centers.

The line units 20 and 22 are line units which have not previously been used in switching centers. The function of these line units is explained in more detail below.

The switching center 10 also contains a main switching array 24 and a central processor 26. The line units 12 to 22 and the central processor 26 are connected in this sequence via subscriber lines 28 to 44 to the main switching array 24, the line units 20 and 22 being respectively connected by two subscriber lines 36 and 38 or 40 and 42 to the main switching array. The switching array 24 contains at least one time switching stage and at least one space switching stage. With the aid of the main switching array 24, signaling connections and user data connections can be switched between the line units themselves and between the line units and the central processor 26. The switching operations are, in this case, controlled from the central processor 26.

For the transmission of signaling messages via the main switching array 24, internal signaling messages which have been defined in accordance with an internal protocol for the switching center 10 are used. The internal protocol resembles the ISUP protocol, but also differs in part from this protocol. With the aid of the internal signaling protocol, messages received in accordance with external signaling protocols can be replicated and passed on to other line units. These line units then pass the messages on again in accordance with external signaling protocols. The internal signaling protocol also contains messages for the connection set-up and for the connection tear-down between various line units 12 to 22. The internal signaling messages have a uniformly structured message header, in which, for example, the entity number of the call and the type of message are specified. In the message body, the actual information is transmitted.

If, for example, a subscriber TlnA connected to the line unit 12 dials the call number of a subscriber TlnB connected to the line unit 14, a set-up message in accordance with the protocol DSS1 is received by the line unit 12. This message is confirmed in accordance with the protocol to the subscriber TlnA by a set-up ACK message. The line unit 12 then begins searching for a peer line unit within the switching center 10. For this purpose, it sets up a signaling connection to the central processor 26 with the aid of internal signaling messages. The line unit 12 transmits the call number of the subscriber TlnB to the central processor 26. The central processor determines a peer line unit on the basis of the call number; in the exemplary embodiment, the line unit 14. The line unit 12 is notified of this via internal signaling messages. The line unit 12 subsequently sets up a signaling connection 46 to the line unit 14 and passes on the received set-up message to the line unit 14 with the aid of an internal signaling message. The line unit 14 then signals to the terminal device of the subscriber TlnB a set-up message in accordance with the standard DSS1.

If, on the other hand, the subscriber TlnA wants to reach a subscriber who is connected to a switching center other than the switching center 10, the central processor 26 determines the line unit 18 as the peer line unit. In this case, an internal signaling connection 48 is set up between the line unit 12 and the line unit 18.

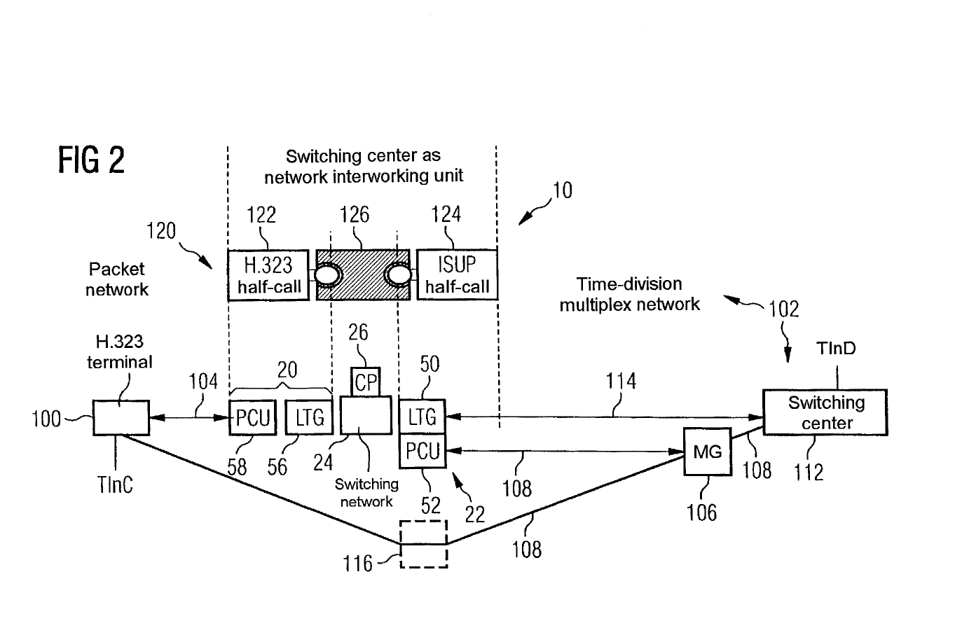

The line unit 20 serves for the conversion between the ISUP protocol and the internal protocol. The conversion takes place in a TRUNK unit 50. The line unit 20 also contains an IP control unit 52 (Internet Protocol), which performs signaling to the outside in accordance with a signaling protocol for packet-transmitting data networks, to be specific in accordance with the Internet protocol. The IP control unit 52 serves for driving a network interworking unit, which is explained below on the basis of FIG. 2. The IP control unit 52 performs signaling to the main switching array 24 likewise in accordance with the internal signaling protocol. This makes it possible to connect the TRUNK unit 50 and the IP control unit 52 via an internal signaling connection 54.

The line unit 22 contains a component line unit 56 and an IP control unit 58. The component line unit 56 serves for the connection of an H.323 terminal device with the IP control unit 58 interposed. Signaling is performed between an H.323 terminal and the IP control unit 58 in accordance with the protocol H.323. The signaling messages arriving in the IP control unit 58 are transmitted to the component line unit 56 via an internal signaling connection 60. The component line unit 56 is also able to be connected to another line unit of the switching center 10 via an internal signaling connection 62, for example to the line unit 20, and there, more precisely, to the TRUNK unit 50. An example of a connection set-up which includes the line units 20 and 22 is explained in more detail below on the basis of FIG. 2.

In another exemplary embodiment, the IP control unit 52 is connected directly to the TRUNK unit 50. The IP control unit 58 is connected directly to the component line unit 56. Directly refers to the main switching array 24 not being included in this internal connection.

FIG. 2 shows functional units of the switching center 10 which serve for the connection of an H.323 terminal 100 to the conventional telephone network 102; for example, the ISDN network. The H.323 terminal 100 is, for example, a computer with a voice input and voice output unit. The computer performs signaling in accordance with the protocol H.323. The voice data are transmitted from and to the H.323 terminal 100 in data packets. The signaling is also performed with the aid of data packets. The H.323 terminal 100 is connected to the IP control unit 22 via a signaling connection 104. The signaling connection 104 is, for example, a component part of an intranet, in which data are transmitted in accordance with the Internet protocol IP. User data can be transmitted between the terminal 100 and a network access unit 106 via the Internet in accordance with the Internet protocol. For the transmission of the voice data, the protocol RTP (Real Time Transfer Protocol), defined in the de facto standard RFC1889 by the ETF, is used. The use of this protocol allows voice data to be transmitted from and to the terminal 100 in real time, i.e., for example, with delays of less than approximately 250 ms.

The network access unit 106 is the interface between the Internet 108 and the telephone network 102. In the network access unit 106, voice data received in data packets are disassembled and passed on in time slots of a PCM-30 link 110 (Pulse Code Modulation) to a switching center 112; for example, a conventional switching center of the EWSD type (electronisches Wählsystem digital [digital electronic dialing system]) of the Siemens AG company. The PCM-30 link 110 is comparatively short, for example only a few meters. The network access unit 106 is controlled from the switching center 10, to be more precise from the IP control unit 52. Since the network access unit 106 is possibly several hundred kilometers away from the switching center 10, it is also referred to as a remote unit.

In the connection set-up between a subscriber TlnC using the terminal 100 and a subscriber TlnD connected to the switching center 112, the following steps are performed:

The terminal 100 generates a set-up message in accordance with the standard H.323, which is sent to the switching center 10. The set-up message contains an IP address, at which the terminal 100 is ready for receiving the voice data from the subscriber TlnD. Also contained in the set-up message is a port number, which specifies the port used for the reception of the voice data. The set-up message also contains a coding identifier or an identifier list for specifying the types of coding which can be selected for the transmission of the user data. The set-up message also contains the call number of the subscriber TlnD in the telephone network 102.

The control unit 22 responds to the set-up message in accordance with the protocol H.323 initially with a call-proceeding message and passes on the set-up message via the internal signaling connection 60; see FIG. 1, the IP address, the port number, the coding identifier and the call number to the component line unit 56. With the inclusion of the central processor 26, the component line unit 56 determines on the basis of the transmitted call number the TRUNK unit 50 as the peer line unit and sets up the internal signaling connection 62. Via this signaling connection leading through the switching array 24, the IP address, the port number, the coding identifier and the call number of the subscriber TlnD in the telephone network 102 are subsequently passed on to the TRUNK unit 50. In the TRUNK unit 50, the internal signaling message is processed. This involves determining a time slot which would have to be used between the switching center 10 and the switching center 112 for transmitting the user data exclusively via the telephone network 102. This time slot corresponds to a channel of the PCM-30 transmission link 110. The Internet address, the port number, the coding identifier and an identification for the time slot are transmitted to the IP signaling unit 52 via the internal signaling connection 54.

The IP control unit 52 generates a CRCX message in accordance with the protocol MGCP for the setting-up of a connection. This message contains the Internet address, the port number, the coding identifier and the identification for the time slot. For the transmission of the signaling message, the Internet 108 is used. In the network access unit 106, the CRCX message is processed. A free Internet address and a free port number, which are to be used for the reception of voice data of the subscriber TlnC, are determined. Furthermore, this Internet address and the port belonging to the port number are linked up with the time slot specified in the CRCX message. In a response message CRCX-ACK, these connection data are sent by the network access unit to the IP control unit 52. The response message corresponds to the protocol MGCP. The IP control unit 52 transmits the connection parameters to the TRUNK unit 50 via the internal signaling protocol.

The TRUNK unit 50 has, in the meantime, generated an IAM message in accordance with the ISUP protocol and transmitted it to the switching center 112 via an inter-exchange line 114. The IAM message contained, inter alia, the call number of the subscriber TlnD and an identification of the time slot determined.

In the switching center 112, the IAM message is processed in accordance with the protocol. An ACM message (Address Complete Message) sent by the switching center 112 to the switching center 10 signals that it was possible for the routing to the subscriber TlnD to be carried out completely by the switching center 112. The subscriber TlnND is then called, for example, by a calling tone of his telephone. The ACM message is processed in accordance with the protocol in the TRUNK unit 50. An internal signaling message, in which notification of the reception of the ACM message is given, is sent to the component line unit 56. The component line unit 56 signals the reception of the ACM message further to the IP control unit 22 with the aid of an internal signaling message. The IP control unit 22 then generates the alerting message in accordance with the protocol H.323 and sends this message to the terminal 100.

Once the subscriber TlnD has taken the call, an ANM message (Answer Message) is generated by the switching center 112 and sent to the switching center 10. The TRUNK unit 50 receives this message and then generates an internal message, which is passed on to the component line unit 56 and signals the arrival of the ANM message. The internal message also contains the connection parameters sent by the network access unit 106. The component line unit 56 passes on the connection parameters contained in the internal signaling message to the IP control unit 22. This involves using an internal signaling message which corresponds to the subscriber signaling message “Connect” of the standard DSS1. After the reception of this internal signaling message, the IP control unit 22 generates a connect message in accordance with the protocol H.323 and sends this message to the terminal 100. The connect message also contains the connection parameters which have been sent by the network access unit 106.

This enables the terminal 100 to transmit voice data from the subscriber TlnC to the network access unit 106 via the Internet 108 in accordance with the protocol RTP (Real Time Protocol). In the opposite direction, the network access unit is able, on the basis of the connection parameters received from the terminal 100, to transmit voice data arriving from the subscriber TlnD via the transmission link 110 to the terminal 100 via the Internet 108 in accordance with the protocol RTP. The port number has been definitively assigned in the network access unit 106 to the time slot on the PCM-30 link 110, so that the user data can be converted with a definitive assignment. In the switching center 112, the time slot defined by the switching center 10 is used for the transmission.

In another exemplary embodiment, the network access unit 106 is located in the switching center 10; see the network access unit 116 represented by dashed lines. The network access unit 116 can then be driven via the internal signaling protocol of the switching center 10. The user data are then transmitted between the switching center 10 and the switching center 112 via the inter-exchange line 114.

In FIG. 2, the functional units of the switching center 10 are also assigned to what is known as the half-call model 120. Toward the calling subscriber TlnC, an H.323 half-call 122 is processed by the switching center 10. Toward the called subscriber TlnD side, the switching center 10 processes an ISUP half-call 124. The two half-calls 122 and 124 can be combined with each other by the internal signaling protocol 126 of the switching center 10.

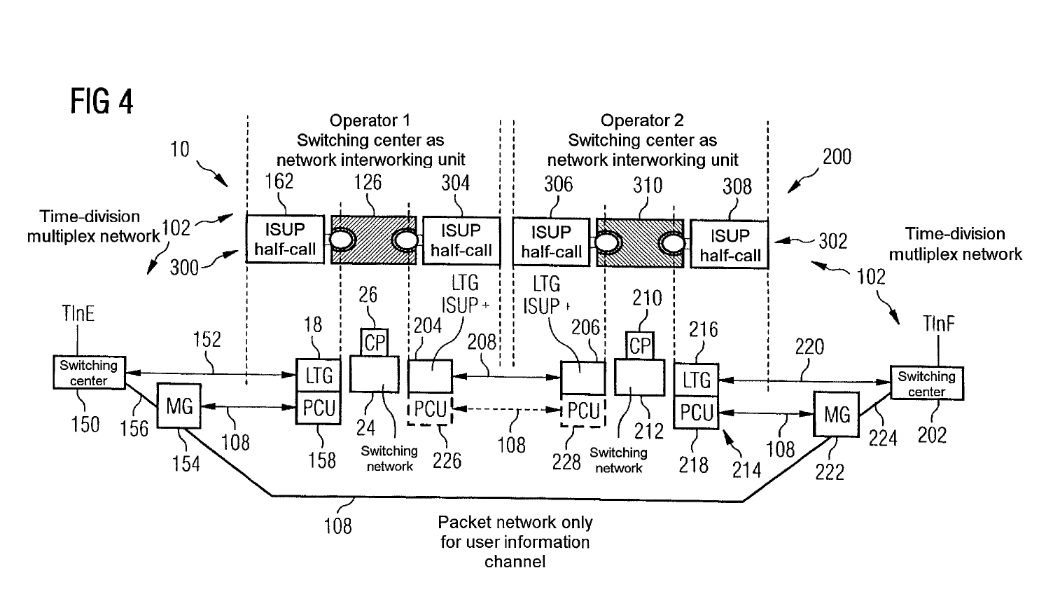

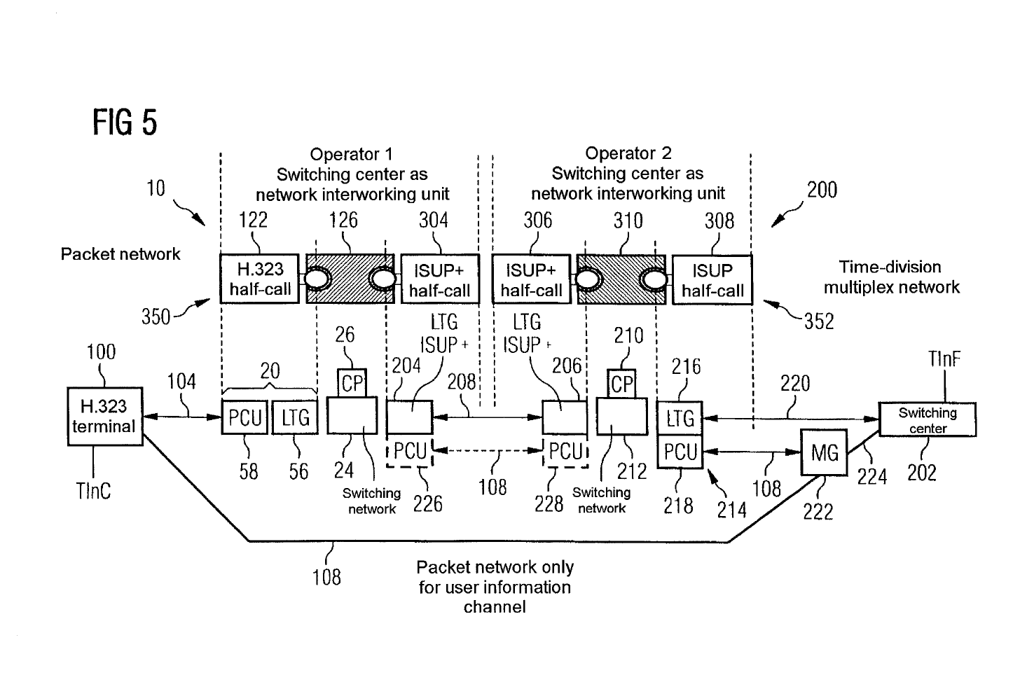

The line unit 20 provides the functions of the H.323 half-call 122 and forms a first protocol converter at the periphery of the switching center 10. The line unit 22 provides the functions of the half-call 124 and forms a further protocol converter at the periphery of the switching center 10. The functions of the internal signaling protocol are provided with the aid of the internal signaling messages, with the aid of the switching network 24 and with the aid of the central processor 26. The half-call model 120 has proven to be very advantageous when interlinking switching centers. This interlinkage may also be used in the case of switching for data transmissions in data packets. Such interlinkages are shown below on the basis of FIGS. 4 and 5.

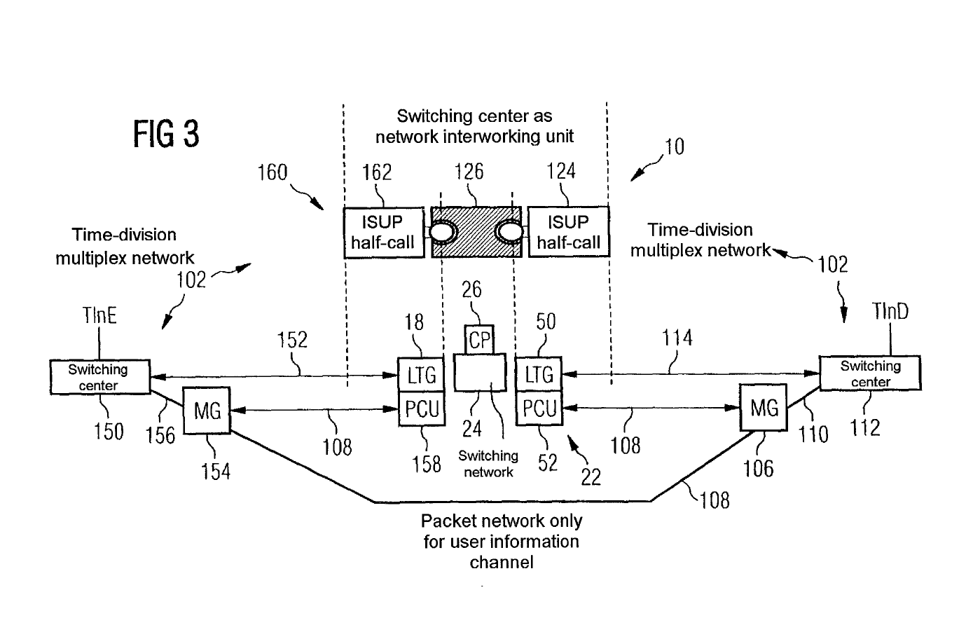

FIG. 3 shows functional units of the switching center 10 in the case of conventional inter-exchange signaling and link-by-link data transmission via the telephone network 102, the Internet 108 and the telephone network 102. The right-hand part of FIG. 3 shows the functional units already explained on the basis of FIG. 2. Let us assume that this time a subscriber TlnE, who is connected to a switching center 150 of the telephone network 102, would like to reach the subscriber TlnD.

The switching center 150 is connected to the switching center 10 via an inter-exchange line 152. The inter-exchange line 152 is connected to the line unit 18, so that signaling messages are exchanged between the switching center 10 and the switching center 150 on the inter-exchange line 152 in accordance with the ISUP protocol. Arranged in the switching center 150, or just a few meters or kilometers away from this switching center 150, is a network access unit 154, to which there leads a PCM-30 link 156, which connects the switching center 150 and the network access unit 154. On the other side, the network access unit 154 is connected to the Internet 108. The network access unit 154 has the conversion functions which have already been explained above for the network access unit 106. The network access unit 124 can be controlled via the Internet 108 from an IP control unit 158 of the switching center 10. The IP control unit 158 is assigned to the line unit 18 during a prolonged operating period of the switching center 10; for example, for operation over several months. In an alternative, the IP control unit 158 can be optionally assigned to the line unit 18.

When setting up a voice connection between the subscriber TlnE and the subscriber TlnD, the process steps explained below are performed.

The switching center 150 sends to the switching center 10 an IAM message, in which a time slot of the PCM-30 link 156 is designated and the call number of the subscriber TlnD is specified. The line unit 18 processes the IAM message and transfers the identification for the time slot to the IP control unit 158.

In accordance with the protocol MGCP, the IP control unit 158 generates a CRCX message (Create Connection) containing the request to the network access unit 154 to connect the designated time slot to an Internet address and a specific port X. This message is processed by a control unit of the network access unit 154. In a response message generated by the network access unit 154, the connection parameters assigned to the time slot, i.e. the Internet address, port number and coding identification, are transmitted.

The line unit 18 determines with the aid of the central processor 26 a peer line unit on the basis of the call number of the subscriber TlnD, to be specific the line unit 50. With the aid of the internal signaling protocol, a connection to the line unit 50 is set up. The wish of the subscriber TlnE for a connection to be set up is signaled to the line unit 50 via this connection. At the same time or later, the connection parameters sent by the network access unit 154 are transmitted to the line unit 50 with the aid of the internal signaling protocol. The call number of the subscriber TlnD is likewise transmitted to the line unit 50 and from there is sent in accordance with the ISUP protocol via the inter-exchange line 114 to the switching center 112 with the aid of an IAM message. Also contained in this message is a time slot which the line unit 50 has determined for the transmission of the user data to the switching center 112. However, this time slot is later used only on a small link, to be specific on the PCM-30 link 110.

The line unit 50 also makes the IP control unit 52 send a CRCX message for connection set-up in accordance with the protocol MGCP to the network access unit 106. Contained in this message are the connection parameters coming from the network access unit 154. The connection set-up message is transmitted by the IP control unit 52 to the network interworking unit 106 via the Internet 108.

The network access unit 106 for its part determines an Internet address and a port number at which it can receive the user data from the network access unit 154. These connection data are transmitted to the IP control unit 52 in a response message in accordance with the protocol MGCP. The IP control unit 52 passes on the connection parameters internally to the line unit 50. The connection parameters are then transmitted via the switching network 24 to the line unit 18 and from there via the IP control unit 158 with the aid of an MDCX message (Modify Connection) to the network interworking unit 154. This takes place at the same time as or independently of the conversion of an ACM message coming from the switching center 112. The further signaling takes place in accordance with the protocol ISUP. If the subscriber TlnD takes the call, the voice data are transmitted between the subscribers TlnD and TlnE via the PCM-30 link 156, the Internet 108 and the PCM-30 link 110, or in the opposite direction. The switching center 10 consequently controls what is known as a backbone network in the central part of the connection; i.e., in the Internet 108.

A half-call model 160 shows which functional units of the switching center 10 are assigned to an ISUP half-call 162 and the half-call 124. The two half-calls 162 and 124 are again linked up via the internal signaling protocol 126 of the switching center 10. The functions of the half-call 162 are provided by the line unit 18 and the IP control unit 158.

FIG. 4 shows functional units of the switching center 10 and a switching center 200, which belong to different operators. The functional units represented in FIG. 4 are used for the switching of a transmission of voice data, which is performed in outlying zones via the telephone network 102 and in a part lying in between via the Internet 108. Let us assume that the subscriber TlnE connected to the switching center 150 would like to speak to a subscriber TlnF who is connected to a switching center 202, which belongs to the same operator as the switching center 200.

The functional units represented in the left-hand third of FIG. 4 correspond to the functional units explained on the basis of FIG. 3. For the signaling with the switching center 200, a line unit 204 which performs signaling in the outward direction in accordance with a supplemented ISUP protocol is used in the switching center 10. In the inward direction, the line unit 204 performs signaling in accordance with an internal signaling protocol. The extension of the protocol ISUP consists in that information elements containing connection data concerning the data transmission within the Internet 108 can be sent from the line unit 204 to a line unit 206 in the switching center 200. These connection data include Internet addresses, port addresses, type-of-coding identifiers, etc. The line units 204 and 206, and consequently also the switching centers 10 and 200, are connected to one another via an inter-exchange line 208.

The switching center 200 is constructed in essentially the same way as the switching center 10. It contains a central processor 210 and a switching network 212. The functions of the central processor 210 and of the switching network 212 correspond to the functions explained on the basis of FIG. 1 for the central processor 26 and the main switching array 24. A line unit 214 corresponds in its construction and its function to the line unit 20. The line unit 214 contains a TRUNK unit 216 and an IP control unit 218. The switching center 200 is connected to the switching center 202 via an inter-exchange line 220.

The IP control unit 218 serves for controlling a network interworking unit 222, which is set up as a remote unit in the switching center 202 or in the proximity of this switching center. The network interworking unit 222 can receive data packets with voice data sent by the network interworking unit 154 or send data packets with voice data to the network interworking unit 154. The network interworking unit 222 is also connected to the switching center 202 via a PCM-30 link (Pulse Code Modulation).

When setting up a voice connection between the subscriber TlnE and the subscriber TlnF, initially the process steps explained above on the basis of FIG. 3 are performed. However, the line unit 18 sets up an internal signaling connection to the line unit 204 on the basis of the call number of the subscriber TlnF. The line unit 204 sends an IAM message to the line unit 206 in accordance with the ISUP protocol. Contained in this IAM message is the call number of the subscriber TlnF. A time slot does not have to be specified, since the user data are in any case transmitted via the Internet 108. In addition to the information elements prescribed in the ISUP protocol, the IAM message does, however, also contain an information element with the connection data which have been transmitted from the network access unit 154 to the switching center 10; i.e., for example, the Internet address, the port number and the type of coding for the reception of data packets in the network access unit 154.

The line unit 206 receives the IAM message and processes this message in accordance with the protocol ISUP. This involves removing the call number of the subscriber TlnF and sending it via the switching network 212 to the central processor 210 with the aid of an internal signaling message. The central processor 210 determines the line unit 216 as its peer entity. An internal signaling connection is then set up between the line units 206 and 216. The line unit 206 passes on the connection data to the line unit 216 via this internal signaling connection. Furthermore, the arrival of the IAM message in the switching center 200 is signaled to the TRUNK unit 216. The TRUNK unit 216 then performs process steps which correspond to the process steps explained on the basis of FIG. 3 for the TRUNK unit 50. Instead of the IP control unit 52, the switching center 112 and the network interworking unit 106, however, the IP control unit 218, the switching center 202 and the network interworking unit 222 are included in the exemplary embodiment explained on the basis of FIG. 3. Once the network interworking unit 222 has, for its part, sent connection data to the IP control unit 214, these data are passed on to the line unit 206 via the trunk unit 216 and the switching network 212. The connection data are transmitted to the line unit 204 with the aid of an APM message. The APM message is prescribed in the ISUP standard. Information elements which contain the Internet address, the port number and the type of coding which are to be used for the connection between the subscriber TlnE and the subscriber TlnF are transmitted in the APM message.

The line unit 204 reads the connection data and sends them to the line unit 18 via an internal signaling message. In the line unit 18, the connection data are transmitted to the IP control unit 158 and from there to the network access unit 154.

If the subscriber TlnF picks up, ANM messages are transmitted in accordance with the protocol between the switching centers 202, 200, 10 and 150. After that, voice data are transmitted from the subscriber TlnE via the switching center 150, the PCM-30 link 156, the network interworking unit 154, the Internet 108, the network interworking unit 222, the PCM-30 link 224 and the switching center 202 to the subscriber TlnF, or in the opposite direction.

In another exemplary embodiment, the line unit 204 is assigned an IP control unit 226. The line unit 206 is assigned an IP control unit 228. Instead of the inter-exchange line 208, the Internet 108 is used for the transmission of the messages in accordance with the supplemented ISUP protocol.

Also represented in FIG. 4 are two half-call models 300 and 302. The half-call model 300 concerns the switching center 10. The half-call 162 toward the subscriber TlnE is formed by the line unit 18 and the IP control unit 158. An ISUP+ half-call 304 exists toward the subscriber TlnF. The functions of the ISUP+ half-call 304 are enabled by the line unit 204 or by the line unit 204 and the IP control unit 226. The two half-calls 162 and 304 can be combined with each other via the internal signaling protocol 126 of the switching center 10.

Toward the subscriber TlnE side, the half-call model 302 contains an ISUP+ half-call 306 and toward the subscriber TlnF side it contains an ISUP half-call 308. The functions of the half-call 306 are provided by the line unit 306 or by the line unit 206 and the IP control unit 228. The functions of the half-call 308 are provided by the line unit 214. The half-calls 306 and 308 can be combined by the internal signaling protocol 310 of the switching center 300.

FIG. 5 shows functional units of the switching centers 10 and 200, which serve for the switching of a connection between the subscriber TlnC and the subscriber TlnF. Functional units with the same designations correspond to the functional units explained above on the basis of FIG. 2 and FIG. 4. The signaling for the connection set-up takes place initially from the terminal 100, as explained above on the basis of FIG. 2. However, the line unit 56 sets up an internal signaling connection to the line unit 204 on the basis of the call number of the subscriber TlnF. The line unit 204 passes on the connection parameters coming from the terminal 100 to the line unit 206 via the inter-exchange line 208 in accordance with the supplemented ISUP protocol in the IAM message. From the line unit 206, these connection data are then passed via the switching network 212 to the line unit 214 and from there to the network interworking unit 222. The network interworking unit 222 for its part sends connection data to the line unit 214. These connection data are transmitted as far as the line unit 204, as explained above on the basis of FIG. 4. The line unit 204 sends the connection data coming from the network interworking unit 222 via the switching network 224 to the line unit 56. From the line unit 56, the connection data are then sent via the IP control unit 58 to the terminal 100. If the subscriber TlNF picks up the receiver, initially an ACM message passes to the switching center 200 and then to the switching center 10 in accordance with the protocol ISUP. Once these messages have been processed, the subscribers TlnC and TlnF can exchange voice data via the Internet 108, the network interworking unit 222, the PCM-30 link 224 and the switching center 202.

In another exemplary embodiment, the Internet 108 is used instead of the inter-exchange line 208 to transmit connection data from the terminal 100 to the network interworking unit 222, or in the opposite direction, as explained above on the basis of FIG. 4. The Internet 108 is also used for the signaling between the two switching centers 10 and 200.

A half-call model 350 contains toward the subscriber TlnC side the H.323 half-call 122 and toward the subscriber TlnF side the half-call 304. The half-calls 122 and 304 can be combined with each other via the internal signaling protocol 126 of the switching center 10.

A half-call model 350 contains toward the subscriber TlnC side the half-call 306 and toward the subscriber TlnF side the ISUP half-call 308. The half-calls 306 and 308 can be combined with each other via the internal signaling protocol 310 of the switching center 200.

In other exemplary embodiments, the subscribers TlnD to TlnF are connected to switching centers other than the switching centers 112, 150 and 202. The switching centers 112, 150 and 202 are then transit switching centers. However, the signaling explained remains fundamentally the same.

Although only the connection set-up phase has been explained on the basis of FIGS. 1 through 5, similar signaling operations are also performed in the signaling tear-down phase. The connections connected in the switching centers are retained between the two signaling phases.

In the transmission of fax data between the subscribers, in a further exemplary embodiment the protocol TCP (Transmission Control Protocol) is used on the Internet. This protocol does not ensure real-time transmission, but is suitable for the transmission of fax data.

Although the present invention has been described with reference to specific embodiments, those of skill in the art will recognize that changes may be made thereto without departing from the spirit and scope of the invention as set forth in the hereafter appended claims.

I claim as my invention

1. A switching process for transmitting user data packets, comprising the steps of:
providing a signaling unit having at least two line units which can be connected to one another and which can be used to set up a connection for transmitting user data;
transmitting the user data in data packets via network nodes of a network;
terminating, via the line units, signaling toward a terminal device involved in the data transmission; and
passing on signaling messages, arriving at one of the line units for switching of the data packets, to another of the line units with the aid of internal signaling messages defined for the signaling unit.

2. A switching process for transmitting user data packets, comprising the steps of:
providing a signaling unit having at least two line units which can be used to set up a connection for transmitting user data;
transmitting the user data in data packets via network nodes of a network;
terminating, via the line units, signaling toward a terminal device involved in the data transmission in accordance with a signaling protocol for circuit-switched transmission of user data; and
passing on signaling messages arriving at one of the line units for switching of the data packets to the other of the line units with the aid of internal signaling messages defined for the signaling unit.

3. A switching process for transmitting user data packets as claimed in claim 2, wherein the line units can be connected to each other.

4. A switching process for transmitting user data packets as claimed in claim 1, wherein the line units can be connected via a switching network which transmits the internal signaling messages via one of channels, a bus system and a data network.

5. A switching process for transmitting user data packets as claimed in claim 1, further comprising the step of:
controlling the connection of the line units according to a connection destination.

6. A switching process for transmitting user data packets as claimed in claim 1, further comprising the step of:
using at least one signaling message to transmit an information element, wherein the information element contains at least one of an address at which one of the terminal device and a network inter-working unit can receive data packets on the terminal device side, a port number which designates a receiving unit of one of the terminal device and the network inter-working unit, and a coding identification which designates a type of coding used sending data packets to one of the terminal device and the network inter-working unit.

7. A switching process for transmitting user data packets as claimed in claim 1, further comprising the steps of:
using further line units for switching user data in a circuit-switched network; and
processing, via the further line units, at least similar internal signaling messages as the line units involved in setting up the connection for the transmission of user data in data packets.

8. A switching process for transmitting user data packets as claimed in claim 1, wherein at least one of the line units involved in the connection set up operates toward the outside in accordance with an ISUP protocol.

9. A switching process for transmitting user data packets as claimed in claim 1, wherein at least one of the line units involved in the connection set up operates toward the outside in accordance with a supplemented ISUP protocol, and the process further comprises the step of using at least one information element for transmitting at least one of an address at which one of the terminal device and a network interworking unit in the packet-switched network can receive data packets, a port number which designates a receiving unit of one of the terminal device and the network inter-working unit, and a coding identification which designates a type of coding used when sending data packets to one of the terminal device and the network inter-working unit.

10. A switching process for transmitting user data packets as claimed in claim 1, wherein at least one of the line units involved in the connection set up terminates the signaling in accordance with a signaling protocol for a packet-transmitting data network.

11. A switching process for transmitting user data packets as claimed in claim 10, wherein the signaling protocol is a protocol for signaling with a terminal device, the protocol being one of an H.323 protocol, an SIP protocol, and an MGCP protocol.

12. A switching process for transmitting user data packets as claimed in claim 10, further comprising the steps of:
transmitting data packets, via the signaling protocol, on a lower protocol layer; and,
transmitting signaling messages, via the signaling protocol, originally defined for a circuit-switch transmission network on an upper protocol layer.

13. A switching process for transmitting user data packets as claimed in claim 1, wherein at least one of the line units involved in the connection set up involves a control unit and a network inter-working unit in the switching operation, and wherein, in the network inter-working unit, after the connection set up, at least one event occurs between removing the user data of the connection from time slots and distributing the user data among data packets, and disassembling the user data of the connection from received data packets and passing the user data on in time slots.

14. A switching process for transmitting user data packets as claimed in claim 13, wherein the at least two line units involve different control units.

15. A switching process for transmitting user data packets as claimed in claim 1, wherein one line unit contains at least two component units which exchange internal signaling messages with one another.

16. A switching process for transmitting user data packets as claimed in claim 10, wherein the user data are passed on in one of a connection list mode by network nodes of the packet-transmitting network in accordance with an IP protocol, and a connection-oriented mode by the network nodes of the packet-transmitting network in accordance with the ATM protocol.

17. A switching signaling unit for transmitting user data packets, comprising:
at least two line units which are used to set up a connection for transmitting user data in data packets; and
at least one terminal device wherein the line units terminate signaling toward one of the terminal devices involved in the data transmission, and signaling messages arriving at one of the line units are passed on to the other of the line units with the aid of internal signaling messages defined for the signaling unit.

18. A switching center for a circuit-switched network, wherein the switching center contains a signaling unit for transmitting user data packets and comprises:
at least two line units which are used to set up a connection for transmitting user data in data packets; and
at least one terminal device wherein the line units terminate signaling toward one of the terminal devices involved in the data transmission, and signaling messages arriving at one of the line units are passed on to the other of the line units with the aid of internal signaling messages defined for the signaling unit.

19. A program having program commands which, when performed, effect a switching process for transmitting user data packets which includes the steps of:
providing a signaling unit having at least two line units which can be connected to one another and which can be used to set up a connection for transmitting user data;
transmitting the user data in data packets via network nodes of a network;
terminating, via the line units, signaling toward a terminal device involved in the data transmission; and
passing on signaling messages, arriving at one of the line units for switching of the data packets, to another of the line units with the aid of internal signaling messages defined for the signaling unit.
